(19) United States
(12) Patent Application Publication
(10) Pub. No.: US 2026/0176457 A1
(43) Pub. Date: Jun. 25, 2026

(54) POLYVINYL CHLORIDE COMPOSITION

(71) Applicant: Solstice Advanced Materials US, Inc., Morris Plains, NJ (US)

(72) Inventors: Wayne King, Columbia, MO (US); Vincent Clarke, Morris Plains, NJ (US)

(73) Assignee: Solstice Advanced Materials US, Inc., Charlotte, NC (US)

(21) Appl. No.: 19/401,638

(22) Filed: Nov. 26, 2025

Related U.S. Application Data
(60) Provisional application No. 63/738,681, filed on Dec. 24, 2024.

(51) Int. Cl. C08L 27/06; B29C 48/00

(52) U.S. Cl. CPC C08L 27/06; B29C 48/022

(57) ABSTRACT

The composition includes from about 50 to about 95 wt % of polyvinyl chloride polyvinyl chloride and from about 0.1 to about 3 wt % of a first lubricant, each based on a total weight of the composition, wherein the first lubricant includes a dimerization product of at least two linear alpha olefins that each includes from about 20 to about 24 carbon atoms; and wherein the dimerization product includes a first compound having from about 33 to about 44 carbon atoms and a second compound having from about 45 to about 60 carbon atoms.

### CROSS-REFERENCE TO RELATED APPLICATION

This application claims the benefit of U.S. Provisional application No. 63/738,681, filed on Dec. 24, 2024, the entire content of which is hereby incorporated by reference.

### TECHNICAL FIELD

The present disclosure generally relates to a composition including polyvinyl chloride and a particular lubricant. More specifically, the lubricant includes a dimerization product of at least two linear alpha olefins that each includes from about 20 to about 24 carbon atoms. The disclosure also relates to a method of forming the composition and method of forming an extruded product using the composition.

### BACKGROUND

Polyvinyl chloride (PVC) is a high-strength thermoplastic material that has been utilized in various industries, e.g. window and door manufacturing, medical device fabrication, water pipes manufacturing, wire and cable insulation, etc.

Generally, PVC is extruded to impart profile shapes to form various products. Extrusion of PVC typically includes heating PVC compositions to facilitate flow and subsequently extruding the PVC by forcing it through a die.

To enhance processability of PVC and/or to efficiently extrude the PVC, PVC compositions generally include adjuvants such as external lubricants for various purposes. For example, external lubricants can reduce surface interaction between the PVC composition and surfaces of an extruder, consequently reducing the energy needed to extrude the PVC and/or improve uniformity of PVC products.

Conventional external lubricants typically are long hydrocarbon chains, e.g. about 30 carbons or more, such as paraffin and polyethylene waxes. However, there are concerns regarding low base oil feedstock availability and consequently, limitation on the production of conventional external lubricants.

Accordingly, there is an opportunity to develop alternative lubricants for PVC applications.

### BRIEF SUMMARY

This disclosure provides a composition including from about 50 to about 95 wt % of polyvinyl chloride, based on a total weight of the composition; and from about 0.1 to about 3 wt % of a first lubricant, based on a total weight of the composition; wherein the first lubricant includes a dimerization product of at least two linear alpha olefins that each includes from about 20 to about 24 carbon atoms; and wherein the dimerization product includes a first compound having from about 33 to about 44 carbon atoms and a second compound having from about 45 to about 60 carbon atoms.

This disclosure also provides a method of forming the composition, the method including the steps of providing the polyvinyl chloride; providing the first lubricant; and combining the polyvinyl chloride and the first lubricant to form the composition such that the polyvinyl chloride is present in an amount of from about 50 to about 95 wt %, and the first lubricant is present in an amount of from about 0.1 to about 3 wt %, each based on a total weight of the composition.

Additionally, the disclosure provides a method of forming an extruded product, the method including the steps of providing the composition; and extruding the composition through a die to form the extruded product.

### BRIEF DESCRIPTION OF THE DRAWINGS

The present disclosure will hereinafter be described in conjunction with the following FIGURE, and

FIG. 1 is a graph of standard Brabender torque (m-gms) vs. time (s) and temperature (° C.) vs. time (s) of PVC compositions of the Examples.

### DETAILED DESCRIPTION

The following detailed description is merely exemplary in nature and is not intended to limit the current composition. Furthermore, there is no intention to be bound by any theory presented in the preceding background or the following detailed description.

Embodiments of the present disclosure are generally directed to polymers, compositions including the same, and methods for forming the same. For the sake of brevity, conventional techniques related to making polymers and such compositions may not be described in detail herein. Moreover, the various tasks and process steps described herein may be incorporated into a more comprehensive procedure or process having additional steps or functionality not described in detail herein. In particular, various steps in the manufacture of polymers and associated compositions are well-known and so, in the interest of brevity, many conventional steps will only be described briefly herein or will be omitted entirely without providing the well-known process details.

In this disclosure, the terminology “about” can describe values ±0.1, 0.5, 1, 2, 3, 4, 5, 6, 7, 8, 9, or 10%, in various embodiments. Moreover, it is contemplated that, in various non-limiting embodiments, it is to be appreciated that all numerical values as provided herein, save for the actual examples, are approximate values with endpoints or particular values intended to be read as “about” or “approximately” the value as recited. It is also contemplated that all isomers and chiral options for each compound described herein are hereby expressly contemplated for use herein in various non-limiting embodiments.

Throughout this disclosure, the terminology percent “actives” is well recognized in the art and means the percent amount of active or actual compound or molecule present as compared to, for example, a total weight of a diluted solution of a solvent and such a compound. Some compounds, such as a solvent, are not described relative to a percent actives because it is well known to be approximately 100% actives. Any one or more of the values describe herein may be alternatively described as percent actives as would be understood by the skilled person.

In various embodiments, the terminology “free of” describes embodiments that include less than about 5, 4, 3, 2, 1, 0.5, or 0.1, weight percent (or weight percent actives) of the compound or element at issue using an appropriate weight basis as would be understood by one of skill in the art. In other embodiments, the terminology “free of” describes embodiments that have zero weight percent of the compound or element at issue.

The terminology “consists essentially of” may describe various non-limiting embodiments that are free of one or more optional compounds described herein and/or free of one or more polymers, surfactants, additives, solvents, etc.

It is to be understood that the subscripts of polymers are typically described as average values because the synthesis of polymers typically produces a distribution of various individual molecules.

The polymers and compositions disclosed herein may suitably comprise, consist of, or consist essentially of the components, elements, and process delineations described herein. The embodiments illustratively disclosed herein suitably may be practiced in the absence of any element which is not specifically disclosed herein.

The composition includes from about 50 to about 95 wt % of polyvinyl chloride, based on a total weight of the composition; and from about 0.1 to about 3 wt % of a first lubricant, based on a total weight of the composition; wherein the first lubricant includes a dimerization product of at least two linear alpha olefins that each includes from about 20 to about 24 carbon atoms; and wherein the dimerization product includes a first compound having from about 33 to about 44 carbon atoms and a second compound having from about 45 to about 60 carbon atoms.

### Composition

The composition includes the PVC and the first lubricant. The composition may be used to produce rigid or flexible PVC. Alternatively, the composition may be used to produce PVC-U (unplasticized PVC), C-PVC (chlorinated PVC), PVC-O (molecularly oriented PVC), and/or PVC-M (modified PVC), e.g. PVC-HI (high impact PVC).

The composition may be further described as a PVC composition, a PVC material, an extrudable PVC, a PVC feed, etc. The composition may be used for various manufacturing processes and may exist in various physical phases, e.g. at different stages of manufacturing processes, different temperatures, pressures, etc. Accordingly, the composition may exist in a solid phase, e.g. as resins, powder, pipes, trims, sheets, etc. or in a liquid phase, e.g. as a molten composition.

### Polyvinyl Chloride

The composition includes the PVC. The PVC may be in various physical forms, e.g. resins, granules, powders, etc. As known in the art, PVC is a polymer that includes a vinyl chloride (CH₂═CHCl) residue as a repeating unit. The repeating unit may be repeated various times to attain various weight average molecular weights (M_{W}).

Typically, the PVC has a weight average M_{W} of from about 30 to about 200 kDa. In various embodiments, the PVC has a weight average M_{W} of from about 30 to about 50 kDa, about 31 to about 49 kDa, about 32 to about 48 kDa, about 33 to about 47 kDa, about 34 to about 46 kDa, about 35 to about 45 kDa, about 36 to about 44 kDa, about 37 to about 43 kDa, about 38 to about 42 kDa, about 39 to about 41 kDa, or about 39 to about 40 kDa. In other embodiments, the PVC has a weight average M_{W} of from about 50 to about 200 kDa, about 60 to about 190 kDa, about 70 to about 180 kDa, about 80 to about 170 kDa, about 90 to about 160 kDa, about 100 to about 150 kDa, about 110 to about 140 kDa, or about 120 to about 130 kDa. In yet other embodiments, the PVC has a weight average M_{W} of from about 30 to about 200 kDa, about 50 to about 150 kDa, or about 50 to about 100 kDa. In various non-limiting embodiments, all values and ranges of values including and between those set forth above are expressly contemplated for use herein.

The PVC may further include, or be free of, an additional residue, and may be further described as a copolymer or a modified polymer. The additional residue may not be limited and may be any known in the art. For example, the additional residue may have from about 1 to about 10 carbon atoms, e.g. about 1 to about 8, about 2 to about 5, etc., may be an alkane, alkene, or alkene, may or may not include a carbonyl group, may or may not have a hetero atom, may be branched or linear, or may be aliphatic or aromatic. Non-limiting examples of additional residues include ethylene, propylene, vinyl acetate, cetyl vinyl ether, vinylidene chloride, etc.

The PVC is present in the composition in various amounts from about 50 to about 95 wt %, based on a total weight of the composition. In various embodiments, the PVC is present in an amount of from about 50 to about 95, about 55 to about 95, about 60 to about 95, about 65 to about 95, about 70 to about 95, about 70 to about 94, about 70 to about 93, about 70 to about 92, about 70 to about 91, about 70 to about 90 wt %, about 71 to about 89 wt %, about 72 to about 88 wt %, about 73 to about 87 wt %, about 74 to about 86 wt %, about 75 to about 85 wt %, about 76 to about 84 wt %, about 77 to about 83 wt %, about 78 to about 82 wt %, about 79 to about 81 wt %, or about 79 to about 80 wt %, based on a total weight of the composition. In other embodiments, the PVC is present in an amount of from about 80 to about 85 wt %, about 81 to about 84 wt %, or about 82 to about 83 wt %, based on a total weight of the composition. In various non-limiting embodiments, all values and ranges of values including and between those set forth above are expressly contemplated for use herein.

### First Lubricant

The composition also includes the first lubricant. The first lubricant may be further described as a PVC lubricant, an external lubricant, a PVC adjuvant, etc. The first lubricant may be used for various purposes, e.g. coating the PVC resins, reducing friction between the PVC and any processing equipment, customizing viscosity and/or flow characteristic of the composition, etc.

The first lubricant includes a dimerization product, also referred to as a dimer, of at least two linear alpha olefins that each independently includes from about 20 to about 24 carbon atoms. The terminology “linear alpha olefin” describes a chemical compound that is a straight-chain hydrocarbon that includes a double bond in a terminal position.

The dimerization reaction joins the at least two linear alpha olefins to form the dimer. In various embodiments, the linear alpha olefins each includes about 20, 21, 22, 23, or 24 carbon atoms, or from about 20 to about 24, about 21 to about 23, about 20 to about 22, etc. carbon atoms. In various non-limiting embodiments, all values and ranges of values including and between those set forth above are expressly contemplated for use herein.

As understood by the skilled person, the linear alpha olefin may further include a small amount, e.g. less than 5 wt % of the total weight of the linear alpha olefin, of a truncated linear alpha olefin. For example, the truncated linear alpha olefin may have about 20 or fewer carbon atoms, about 15 or fewer carbon atoms, about 10 or fewer carbon atoms, or about 5 or fewer carbon atoms, etc. The truncated linear alpha olefin may be present in an amount of less than about 5 wt %, less than about 4 wt %, less than about 3 wt %, less than about 2 wt %, less than about 1 wt %, less than about 0.5 wt %, or less than about 0.1 wt %, based on a total weight of the linear alpha olefin. In various non-limiting embodiments, all values and ranges of values including and between those set forth above are expressly contemplated for use herein.

Depending on the type of linear alpha olefin and the number of linear alpha olefins reacted, the dimerization product can vary in chain length. Typically, the dimerization product includes from about 33 to about 66 carbon atoms. In various embodiments, the dimerization product includes about 33, 34, 35, 36, 37, 38, 39, 40, 41, 42, 43, or 44 carbon atoms, or from about 35 to about 40 carbon atoms, about 33 to about 40, or about 35 to about 44 carbon atoms. In other embodiments, the dimerization product includes about 45, 46, 47, 48, 49, 50, 51, 52, 53, 54, 55, 56, 57, 58, 59, 60, 61, 62, 63, 64, 65, or 66 carbon atoms, or from about 45 to about 60 carbon atoms, about 45 to about 50, about 50 to about 60, or about 50 to about 55 carbon atoms. The dimerization product may include one or more compounds, e.g., one, two, three, four, five, etc. different compounds. In various embodiments, the dimerization product includes a first compound having from about 33 to about 44 carbon atoms and a second compound having from about 45 to about 66 carbon atoms. In various non-limiting embodiments, all values and ranges of values including and between those set forth above are expressly contemplated for use herein.

The linear alpha olefins may react in any orientation known in the art, e.g. tail-to-tail, head-to-head, head-to tail, or cross-dimerization. The orientation of the linear alpha olefins can form the dimerization product that is mostly linear or low branching, e.g. having a degree of branching (DB) of from about 0 to about 10%, moderate branching, e.g. DB of from about 10 to about 30%, or high branching, e.g. DB of from about 30 to about 60%. Branching of the dimerization product may be further described as iso-, anteiso- or poly-branched. Typically, from about 60 to about 80 wt % of the dimerization product exhibits low branching. In various embodiments, from about 60 to about 80 wt %, about 65 to about 75 wt %, or about 65 to about 70 wt % of the dimerization product exhibits low branching. In various non-limiting embodiments, all values and ranges of values including and between those set forth above are expressly contemplated for use herein.

Accordingly, from about 20 to about 40 wt % of the dimerization product may exhibit moderate to high branching. In various embodiments, from about 20 to about 40 wt %, about 25 to about 35, or about 20 to about 30 wt % of the dimerization product exhibits moderate to high branching. In various non-limiting embodiments, all values and ranges of values including and between those set forth above are expressly contemplated for use herein.

The joining of at least two linear alpha olefins may form the dimerization product that includes various numbers of double bonds, e.g. 0, 1, 2, 3, or 4. Accordingly, the dimerization product may be an alkane or alkene. In various non-limiting embodiments, all values and ranges of values including and between those set forth above are expressly contemplated for use herein.

When the dimerization product includes a double bond, its location in the carbon chain may be in any position, which may depend on the orientation of the linear alpha olefins during the dimerization reaction. For example, the double bond may be in a terminal position, a non-terminal position, or in both terminal and non-terminal positions.

The first lubricant may exhibit various viscosities which can be measured at an elevated temperature, e.g. at about 80° C. or greater, at about 100° C. or greater, about 120° C. or greater, about 140° C. or greater, about 160° C. or greater, about 180° C. or greater, or about 200° C. or greater, etc. In various embodiments, the viscosity may be further described as a kinematic viscosity and may be measured at about 98.9° C. In other embodiments, the viscosity may be further described as a dynamic viscosity and may be measured at about 100° C. The viscosity of the first lubricant at any of the aforementioned temperatures may be measured using any standardized method known in the art, e.g. ISO 17025, ISO 17034, ASTM D2196, ASTM D445, etc. Various analytical instruments and apparatus may also be used, e.g. a rotary viscometer such as a Brookfield viscometer, using various settings, e.g. with a spindle speed of from about 4 to about 250 rpm, e.g. about 4 to about 10, about 10 to about 200, about 50 to about 150 rpm, etc. using a sheer rate of about 100 to about 350 s⁻¹, e.g. about 150 to about 300, about 200 to about 250 s⁻¹, etc. In various non-limiting embodiments, all values and ranges of values including and between those set forth above are expressly contemplated for use herein.

The first lubricant may exhibit a viscosity, measured using any of the aforementioned methods, settings, and/or temperatures of from about 1 to about 50 cP. In various embodiments, the viscosity of the first lubricant is from about 1 to about 10 cP, about 2 to about 9 cP, about 3 to about 8 cP, about 4 to about 7 cP, or about 5 to about 6 cP. In other embodiments, the viscosity of the first lubricant is from about 10 to about 50, about 15 to about 45 cP, about 20 to about 40 cP, about 25 to about 35 cP, or about 25 to about 30 cP. In various non-limiting embodiments, all values and ranges of values including and between those set forth above are expressly contemplated for use herein.

The first lubricant is present in the composition in an amount of from about 0.1 to about 3 wt %. In various embodiments, the first lubricant is present in an amount of from about 0.1 to about 3 wt %, about 0.5 to about 2.5 wt %, or about 1 to about 2 wt %, based on a total weight of the composition. In other embodiments, the first lubricant is present in an amount of from about 0.1 to about 1 wt %, about 0.2 to about 0.9 wt %, about 0.3 to about 0.8 wt %, about 0.4 to about 0.7 wt %, or about 0.5 to about 0.6 wt %, based on a total weight of the composition. In various non-limiting embodiments, all values and ranges of values including and between those set forth above are expressly contemplated for use herein.

### Additional Components

The composition may also include, or be free of, an additional component. The additional component may be or include a second lubricant, a filler, an organometallic compound, an additive, etc. Additional components may be included for various purposes, e.g. customizing physical properties of the composition, improving extruding performance, etc.

In some embodiments, a second lubricant may be included in the composition. The second lubricant may be further described as an internal lubricant, a metal release agent, etc., which can help reduce cohesive forces of the composition and/or reducing viscosity of the composition, improving flow properties and processibility of the PVC, etc. Non-limiting examples of second lubricants include steric acid compounds such as calcium stearate, zinc stearate, glycerol monostearate, butyl stearate, octyl stearate, etc.; and waxes such as a polyethylene wax, a montan wax, an amide wax, modified soybean wax, etc. In various examples, the second lubricant is or includes calcium stearate.

The second lubricant may be present in the composition in various amounts of from about 0 to about 3 wt %. In various embodiments, the second lubricant is present in an amount of from about 0 to about 1, about 0.1 to about 1 wt %, about 0.2 to about 0.9 wt %, about 0.3 to about 0.8 wt %, about 0.4 to about 0.7 wt %, or about 0.5 to about 0.6 wt %. In various embodiments, the second lubricant is present in an amount of from about 1 to about 3, about 1.5 to about 3, about 1.5 to about 2.5, about 1 to about 2, about 1.5 to about 2, about 2 to about 3, about 2.5 to about 3. In various non-limiting embodiments, all values and ranges of values including and between those set forth above are expressly contemplated for use herein.

The composition may additionally and optionally include a filler. The filler may be included for various purposes, e.g. to customize physical and mechanical properties such as surface finish, dimensional stability, density, etc. Non-limiting examples of fillers include calcium carbonate, silicon dioxide, barium sulfate, calcium metasilicate, aluminum silicate, magnesium silicate, fly ash, etc. In various embodiments, the filler is or includes calcium carbonate.

The filler may be present in the composition in an amount of from about 0 to about 20 wt %. In various embodiments, the filler is present in an amount of from about 1 to about 20, about 1 to about 15, about 1 to about 10, about 1 to about 9 wt %, about 2 to about 8 wt %, about 3 to about 7 wt %, about 4 to about 6 wt %, or about 4 to about 5 wt %. In other embodiments, the filler is present in an amount of from about 5 to about 15, 10 to about 20, about 11 to about 19, about 12 to about 18, about 13 to about 17, about 14 to about 16, or about 14 to about 15 wt %. In various non-limiting embodiments, all values and ranges of values including and between those set forth above are expressly contemplated for use herein.

The composition may include, or be free of, an organometallic compound and/or organic salt. The organometallic compound and/or organic salt can be included in the composition for various purposes, but typically as a heat stabilizer.

As known in the art, the terminology “organometallic” describes a type of chemical compound that includes at least one covalent bond between a carbon atom and a metal atom, typically a transition metal, e.g. zinc, lead, tin, etc. Relative to the organic salt, the terminology “organic salt” describes a chemical compound that includes an anion and a cation wherein the anion and/or the cation include an organic group, e.g. carbonyl group, hydrocarbyl group, etc.

The organometallic compound and/or organic salt may include metals chosen from tin, lead, zinc, calcium, barium, and combinations thereof. Non-limiting examples of organometallic compound and/or organic salt include organotin compounds, e.g. methyltin 2-ethylhexyl mercaptoacetate, methyltin-2-mercaptoethyloleate sulfide, butyltin trichloride, dimethyltin oxide, dioctyltin di(isooctyl thioglycolate), dioctylbis(isooctyl maleate)tin, dioctyltin dilaurate, butyl mercaptan oxy-stannane, diisooctyl 2,2′-[(dimethylstannylene)bis(thio)]diacetate, etc., organic salts, e.g. calcium oleate, stannous oleate, cadmium stearate, zinc laurate, calcium dodecanoate, barium dodecanoate, etc. In various embodiments, the organometallic compound and/or organic salt is or includes methyltin 2-ethylhexyl mercaptoacetate.

In various embodiments, the organometallic compound and/or organic salt is present in an amount of from about 0 to about 10 wt %, based on a total weight of the composition. In other embodiments, the organometallic compound is present in an amount of from about 1 to about 9 wt %, about 2 to about 8 wt %, about 3 to about 7 wt %, about 4 to about 6, or about 4 to about 5 wt %, based on a total weight of the composition. In various non-limiting embodiments, all values and ranges of values including and between those set forth above are expressly contemplated for use herein.

The composition may additionally and optionally include a metal-free heat stabilizer. Non-limiting examples of metal-free heat stabilizers include 2,2-dioctyl-1,3,2-dioxastannepine-4,7-dione, 2-butenedioic acid (2z)-, 1,1′-(dibutylstannylene) 4,4′-diisooctyl ester, 2,2-dimethyl-1,3-propanediyl dioleate, etc.

In various embodiments, the metal-free heat stabilizer is present in an amount of from about 0 to about 10 wt %, based on a total weight of the composition. In other embodiments, the additional heat stabilizer compound is present in an amount of from about 1 to about 9 wt %, about 2 to about 8 wt %, about 3 to about 7 wt %, about 4 to about 6, or about 4 to about 5 wt %, based on a total weight of the composition. In various non-limiting embodiments, all values and ranges of values including and between those set forth above are expressly contemplated for use herein.

The compositional may additionally and optionally include an additive. The additive may be included for various purposes, e.g. as a processing aid, as an impact modifier, etc. In various embodiments, the additive is chosen from an acrylic homopolymer, an acrylic copolymer, a chlorinated polyethylene, a methyl methacrylate-butadiene-styrene copolymer, and combinations thereof.

The additive may be present in an amount of from about 0 to about 10 wt %, based on a total weight of the composition. In various embodiments, the additive is present in an amount of from about 0 to about 10 wt %, about 1 to about 9 wt %, about 2 to about 8 wt %, about 3 to about 7 wt %, about 4 to about 6, or about 4 to about 5 wt %, based on a total weight of the composition. In various non-limiting embodiments, all values and ranges of values including and between those set forth above are expressly contemplated for use herein.

The composition may additionally include or be free of a thermoplastic that is different from PVC. Examples of these additional thermoplastics include extrudable thermoplastics such as polycarbonates, ABS plastics, high engineering plastics, etc. In various embodiments, the additional thermoplastic is present in an amount of from about 0 to about 30 wt %, about 1 to about 25, about 5 to about 20, or about 10 to about 15 wt %, based on a total weight of the composition. In various non-limiting embodiments, all values and ranges of values including and between those set forth above are expressly contemplated for use herein.

### Method of Forming the Composition

This disclosure additionally provides a method for forming the composition. The method includes the steps of providing the PVC, providing the first lubricant, and combining the polyvinyl chloride and the first lubricant to form the composition.

The step of providing the PVC is not particularly limited and may be any known in the art. For example, as first described above, the PVC may be provided in various physical forms, e.g. resins, granules, powders, etc. The PVC may be manufactured in-house, e.g. from ethylene and chlorine to form ethylene dichloride (EDC), followed by a thermal cracking process. Alternatively, the PVC may be acquired commercially. The step of providing the PVC may additionally include a step of preparing the PVC to be included in the composition, e.g. weighing the PVC, grinding the PVC, etc.

The step of providing the first lubricant is also not particularly limited and may be any known in the art. The first lubricant may be provided from in-house and/or external sources. In various embodiments, the step of providing the first lubricant is further described as dimerizing linear alpha olefins. The step of dimerizing the linear alpha olefins may be performed using any chemical reaction known in the art, e.g. using a catalytic dimerization, using an acid-catalyzed dimerization, using a radical-mediated dimerization, etc.

The step of providing the first lubricant may additionally include a step of preparing the linear alpha olefins to be included in the composition, e.g. heating the first lubricant, mixing the first lubricant, and/or customizing the viscosity of the lubricant using various techniques such as dilution, addition of an additive, etc.

The PVC and the first lubricant may be combined using any method known in the art. The step of combining may be performed continuously or in batches. The PVC and/or the first lubricant may be combined in-part or in-whole. The step of combining may be further described as the step of blending and may be performed using various tools, equipment, or apparatus, e.g. a blender, a high-speed mixer, a melt compounding equipment, etc.

The PVC and the first lubricant may be combined in various amounts, so long as the PVC is present in an amount of from about 50 to about 95 wt %, and the first lubricant is present in an amount of from about 0.1 to about 3 wt %, each based on a total weight of the composition. The step of combining may additionally include the step of combining any of the aforementioned additional components, and/or homogenizing the additional components with the PVC and the first lubricant.

The method of forming the composition may further include the step of heating the PVC and the first lubricant, e.g. to soften and subsequently fuse the PVC and the first lubricant to form the composition. The step of heating may be performed before and/or after the step of combining. The PVC, the first lubricant, and/or any additional component may be heated to various temperatures, e.g. about 100° C. or greater, about 110° C. or greater, about 120° C. or greater, about 130° C. or greater, or about 140° C. or greater. In various embodiments, the step of blending can heat PVC, the first lubricant, and/or any additional component, e.g. through shear heating.

The step of heating can melt individual PVC clusters, particulates, resins, or granules and fused them with other components, e.g. the first lubricant and any additional component, to form the composition. The point at which components in the compositions are fused together may be described as “fusion point”. The step of blending and/or heating may be performed for a period of time (a fusion time delay) to reach the fusion point. The fusion time delay may be measured using various techniques and instruments known in the art, for example, measured according to ASTM D2538-02 and/or using a Brabender torque rheometer.

In various embodiments, the fusion time delay measured using any of the aforementioned methods, is from about 30 to about 90 s, depending on the amount of the components in the composition, settings of the rheometer, etc. In other embodiments, the fusion time delay is from about 30 to about 60 s, about 35 to about 55 s, or about 40 to about 50 s. In other embodiments, the fusion time delay is from about 60 to about 90 s, about 65 to about 85 s, or about 70 to about 80 s. In various non-limiting embodiments, all values and ranges of values including and between those set forth above are expressly contemplated for use herein.

The fusion time delay may be further described in comparison to the fusion time delay of a comparative composition that is free of the first lubricant and includes the polyvinyl chloride and a C30 linear alpha olefin or a paraffin wax present in the same amount as the first lubricant. For example, the fusion time delay of the composition may be at least about 10% greater than the fusion time delay of the comparative composition. In various embodiments, the fusion time delay of the composition is about at least 10%, at least 15%, at least 20%, at least about 25%, at least about 30%, at least about 35%, at least about 40%, at least about 45%, or at least about 50%, greater than the fusion time delay of the comparative composition. In various non-limiting embodiments, all values and ranges of values including and between those set forth above are expressly contemplated for use herein.

Generally, at the fusion point, the viscosity of the composition is maximized. The viscosity at fusion point may be described as “fusion viscosity”. The fusion viscosity may be measured using any of the methods first described above, e.g. using a standardized test such as ASTM D445, using a Brookfield viscometer, using a torque rheometer, etc. The fusion viscosity of the composition is not particularly limited and may depend on components included in the composition and their amounts. In various embodiments, the composition is described as “extrudable” and has a fusion viscosity of from about 1 to about 10 Nm, about 2 to about 9 Nm, about 3 to about 8 Nm, about 4 to about 7 Nm, or about 5 to about 6 Nm. In other embodiments, the fusion torque is from about 2 to about 5 Nm, about 2.5 to about 4.5 Nm, about 3 to about 4 Nm, or about 3.5 to about 4 Nm. In yet other embodiments, the fusion viscosity is from about 4 to about 8 Nm, about 4.5 to about 7.5 Nm, about 5 to about 7 Nm, about 5.5 to about 6.5, or 5.5 to about 6 Nm. In various non-limiting embodiments, all values and ranges of values including and between those set forth above are expressly contemplated for use herein.

The fusion viscosity of the composition may be compared to the fusion viscosity of a comparative composition that is free of the first lubricant and includes the polyvinyl chloride and a C30 linear alpha olefin or a paraffin wax present in the same amount as the first lubricant. In various embodiments, the fusion viscosity of the composition is at least about 10%, at least 15%, at least 20%, at least about 25%, at least about 30%, at least about 35%, at least about 40%, at least about 45%, or at least about 50%, less than the fusion viscosity of the comparative composition. In various non-limiting embodiments, all values and ranges of values including and between those set forth above are expressly contemplated for use herein.

Torque is used to blend the composition at the fusion viscosity. This torque may be described as “fusion torque”. The fusion torque of the composition may vary depending on the components included, the amount of each component, and/or the end-use application of the composition e.g. soft PVC, rigid PVC, etc. The fusion torque may be measured using various techniques and instruments known in the art, for example, measured according to ASTM D2538-02 and/or using a Brabender torque rheometer. In various embodiments, the fusion torque is from about 1 to about 10 Nm, about 2 to about 9 Nm, about 3 to about 8 Nm, about 4 to about 7 Nm, or about 5 to about 6 Nm. In other embodiments, the fusion torque is from about 2 to about 5 Nm, about 2.5 to about 4.5 Nm, about 3 to about 4 Nm, or about 3.5 to about 4 Nm. In yet other embodiments, the fusion torque is from about 4 to about 8 Nm, about 4.5 to about 7.5 Nm, about 5 to about 7 Nm, about 5.5 to about 6.5, or 5.5 to about 6 Nm. The unit “Nm” may also be expressed as “m-kgms”. Furthermore, the fusion torque may be expressed in the unit of “m-gms”. Accordingly, the fusion torque, expressed in m-gms, may be from about 1000 to about 10,000 m-gms, about 2000 to about 9000, about 3000 to about 8000, about 4000 to about 7000, or about 5000 to about 6000 m-gms, etc. In various non-limiting embodiments, all values and ranges of values including and between those set forth above are expressly contemplated for use herein.

In various embodiments, the fusion torque used to form the composition is less than the fusion torque used to form a comparative composition that is free of the first lubricant and includes the polyvinyl chloride and a C30 linear alpha olefin or a paraffin wax present in the same amount as the first lubricant. In some embodiments, the fusion torque used to form the composition is at least about 10%, at least 15%, at least 20%, at least about 25%, at least about 30%, at least about 35%, at least about 40%, at least about 45%, or at least about 50%, less than the fusion torque used to form the comparative composition. In various non-limiting embodiments, all values and ranges of values including and between those set forth above are expressly contemplated for use herein.

During the step of blending, a steady state can be achieved when the viscosity and the temperature of the composition reaches an equilibrium. With continued blending, the composition can cross-link, and the viscosity of the composition can increase. The time between the fusion point and the beginning of a measurable increase in the viscosity due to cross-linking can be further described as stability time. The stability time may be measured following any standardized test methods, and/or using any instruments known in the art, as first described above. In various embodiments, the stability time is measured using a Brabender Torque Rheometer, and/or according to ASTM D2538-02.

In various embodiments, the stability time is about 30 or greater, about 90 s or greater, about 2 minutes or greater, about 3 minutes or greater, about 4 minutes or greater, about 5 minutes or greater, about 6 minutes or greater, about 7 minutes or greater, about 8 minutes or greater, about 9 minutes or greater, or about 10 minutes or greater, depending on the amount of the components in the composition, settings of the rheometer, etc. In other embodiments, the stability time is from about 30 s to about 10 minutes, about 60 s to about 9 minutes, about 90 s to about 8 minutes, about 2 minutes to about 7 minutes, about 3 minutes to about 6 minutes, or about 4 minutes to about 5 minutes. In various non-limiting embodiments, all values and ranges of values including and between those set forth above are expressly contemplated for use herein.

The stability time may be further described in comparison to the stability time of a comparative composition that is free of the first lubricant and includes the polyvinyl chloride and a C30 linear alpha olefin or a paraffin wax present in the same amount as the first lubricant. For example, the stability time of the composition may be at least about 10% greater than the stability time of the comparative composition. In various embodiments, the stability time of the composition is about at least 10%, at least 15%, at least 20%, at least about 25%, at least about 30%, at least about 35%, at least about 40%, at least about 45%, or at least about 50%, greater than the stability time of the comparative composition. In various non-limiting embodiments, all values and ranges of values including and between those set forth above are expressly contemplated for use herein.

### Method of Forming an Extruded Product

This disclosure also provides a method of forming an extruded product. The extruded product may be any known in the art. For example, the extruded product may be a pipe, a sheet, a window or door profile, an article, etc. The method includes the steps of providing the composition and extruding the composition through a die to form the extruded product.

The step of providing the composition may be any known in the art and is not particularly limited. The step of providing the composition may be further described as feeding the composition into an extruder. The step of feeding may further include the step of loading the composition into a hopper, which may be performed manually, or automatically, e.g. using a pneumatic conveyor, a vacuum loader, etc.

The step of feeding may be performed using any technique and/or feeder known in the art. For example, a gravimetric feeder may be used to control feed rate by controlling the weight of the composition being fed into the extruder. Alternatively, a volumetric feeder may be used to control feed rate by controlling the volume of the composition being fed into the extruder.

The composition may be fed into an extruder at various feed rates. The feed rate can be customized, depending on components included in the composition, temperature, and/or type of feeder. A fast feed rate, e.g. greater than about 1 mm per revolution (mm/rev), may overwork the extruder, leading to incomplete melting and/or inconsistent extrusion. However, a low feed rate, e.g. less than about 0.1 mm/rev, may cause underfeeding, resulting in poor product quality. Accordingly, the feed rate can vary from about 0.1 to about 1 mm/rev. In various embodiments, the feed rate is from about 0.1 to about 1 mm/rev, about 0.2 to about 0.9 mm/rev, about 0.3 to about 0.8 mm/rev, about 0.4 to about 0.7 mm/rev, or about 0.5 to about 0.6 mm/rev. In various non-limiting embodiments, all values and ranges of values including and between those set forth above are expressly contemplated for use herein.

Furthermore, the step of providing the composition may further include the step of preparing the composition for extruding, such as preheating the composition, e.g. to enhance flow characteristics, reduce force used during extrusion, and/or maintain a stable feed. Typically, before the step of feeding, the composition may be heated to a temperature of from about 60 to about 80° C., about 65 to about 75° C., or about 65 to about 70° C. In various non-limiting embodiments, all values and ranges of values including and between those set forth above are expressly contemplated for use herein.

The method also includes the step of extruding the composition through a die to form the extruded product. The step of extruding may be performed using any type of extruder known in the art, e.g. single screw, twin screw, planetary, etc. The composition may be extruded through a die of various diameters, which generally depends on the type of the extruded product being manufactured. For example, to form a small pipe, the die diameter can vary from about 5 to about 50 mm, e.g. about 10 to about 40 mm, or about 20 to about 30 mm. Alternatively, to form a window profile, the die diameter can vary from about 50 to about 200 mm, e.g. about 60 to about 180 mm, about 70 to about 160 mm, about 90 to about 140 mm, or about 110 to about 120 mm. To make films and/or sheets, the die diameter may vary from about 500 to about 3000 mm, e.g. about 600 to about 2500 mm, about 700 to about 2000 mm, or about from about 800 to about 1500 mm. In various non-limiting embodiments, all values and ranges of values including and between those set forth above are expressly contemplated for use herein.

### EXAMPLES

Two PVC compositions were formed by combining the components as set forth in Table 1. Notably, Exemplary Composition 1 includes the inventive dimerization product, e.g. as a lubricant and is free of other external lubricants.

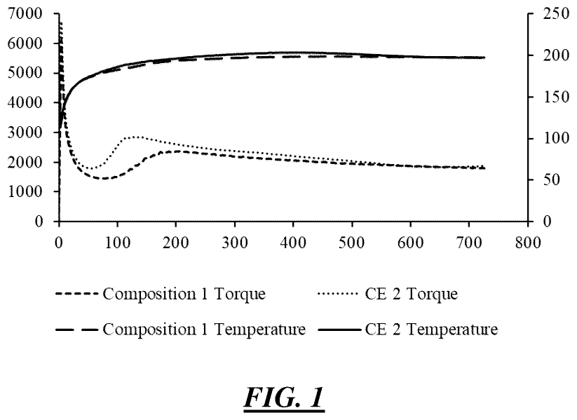

Rheology data of the PVC compositions were obtained using a Brabender Plastogram Plasti-corder and mixer Measuring Head, using a speed of about 80 rpm, a mixer temperature at 180° C., a start temperature of about 177° C., a measuring range of about 5000 mg, a damping of 5, and a sample mass of about 67 g. The curves of torque (m-gms) versus time (s) and temperature (° C.) versus time (s) of both the Exemplary Composition 1 and the Comparative Composition 2 are presented in FIG. 1. Additionally, the fusion time, fusion torque, torque at 12 minutes, and temperature at 12 minutes of the two compositions were determined from the curves and are summarized in Table 2 below.

TABLE 1
Components of Exemplary Composition
and Comparative Composition.

| | | Exemplary | Comparative |
|---|---|---|---|
| | | Composition | Composition |
| | | 1 | 2 |
| Components | Chemical Identity | (parts) | (parts) |
| PVC Resin | polyvinyl chloride | 100 | 100 |
| | homopolymer | | |
| Heat stabilizer | heat ester methyltin | 0.4 | 0.4 |
| | stabilizer | | |
| Metal release | Low density Oxidized | 0.15 | 0.15 |
| agent | Polyethylene | | |
| | homopolymer | | |
| Calcium stearate | | 0.6 | 0.6 |
| Calcium carbonate | | 5 | 5 |
| Titanium dioxide | | 1 | 1 |
| Standard lubricant | 165 std type | 0 | 1.25 |
| | external lubricant | | |
| Dimer | Dimerization product | 1.25 | 0 |
| | of C20-24 linear | | |
| | alpha olefin | | |

TABLE 2
Rheology Data of Exemplary Composition
and Comparative Composition.

| | Exemplary | Comparative |
|---|---|---|
| | Composition | Composition |
| Measurement | 1 | 2 |
| Fusion Time (s) | 202 | 126 |
| Fusion Torque (m-gms) | 2380 | 2881 |
| Torque at 12 minutes (m-gms) | 1806 | 1806 |
| Temperature at 12 minutes (° C.) | 197 | 200 |

The rheology data in FIG. 1, and Table 2 show the performance of the composition that includes 1.25 phr, or 1.25 wt %, of the dimerization product of the linear alpha olefin in comparison to a comparative example which includes a 165 std type external lubricant. At the same loading, i.e. 1.25 phr, the dimerization product provides a longer fusion time compared to the 165 std type external lubricant (202 s vs. 126 s). This means that the dimerization product can be used at a lower loading (phr) and can still achieve the same fusion time as a standard external lubricant. This low loading can be beneficial and advantageous over the art, e.g. in reducing amount of materials used and formulation cost for PVC processes.

Additionally, the composition also provides a lower equilibrium temperature (197 vs. 200° C.) compared to the comparative example, which is indicative of a more efficient lubrication and a lower phr loading demand, which are beneficial for the reasons described above. The lower equilibrium temperature also allows the use of less heat stabilizer for the same loading of the lubricant, e.g. during extrusion processing. Additionally, the lower equilibrium temperature achieved using the dimerization product can allow the use of lower machine processing temperatures, which can result in superior color and appearance of end products.

Furthermore, using the dimerization product, a lower fusion torque can be used (2380 vs 2880 m-gms), which can also be beneficial because a greater output can be achieved at the same machine torque, reducing energy consumption in PVC processes and prolonging the lifespan of equipment.

Overall, the inventive use of the dimerization product in PVC compositions provides superior and unexpected results over the industry standard, i.e. 165 std type external lubricant, as indicated in longer fusion time, lower equilibrium temperature, and lower fusion torque at the same phr loading.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A composition comprising:
from about 50 to about 95 wt % of polyvinyl chloride, based on a total weight of the composition; and
from about 0.1 to about 3 wt % of a first lubricant, based on a total weight of the composition;
wherein the first lubricant comprises a dimerization product of at least two linear alpha olefins that each comprises from about 20 to about 24 carbon atoms; and
wherein the dimerization product comprises a first compound having from about 33 to about 44 carbon atoms and a second compound having from about 45 to about 60 carbon atoms.

2. The composition of claim 1 wherein the first compound is present in an amount of from about 70 to about 90 wt % and the second compound is present from about 10 to about 30 wt %, each based on a total weight of the composition.

3. The composition of claim 1 wherein from about 60 to about 80 wt % of the dimerization product exhibits a degree of branching of from about 0 to about 10%; and from about 20 to about 40 wt % of the dimerization product exhibits a degree of branching of from about 10 to about 60%.

4. The composition of claim 1 wherein the polyvinyl chloride is present in an amount of from about 80 to about 85 wt %, based on a total weight of the composition.

5. The composition of claim 1 wherein the first lubricant is present in an amount of from about 0.5 to about 1.5 wt %, based on a total weight of the composition.

6. The composition of claim 1 further comprising a second lubricant chosen from calcium stearate, a fatty acid ester, and combinations thereof.

7. The composition of claim 6 wherein the second lubricant is present in an amount of from about 0 to about 3 wt %, based on a total weight of the composition.

8. The composition of claim 1 further comprising a filler chosen from calcium carbonate, silicon dioxide, barium sulfate, calcium metasilicate, aluminum silicate, magnesium silicate, fly ash, and combinations thereof.

9. The composition of claim 8 wherein the filler is present in an amount of from about 0 to about 20 wt %, based on a total weight of the composition.

10. The composition of claim 1 further comprising an organometallic compound and/or an organic salt that comprises a metal wherein the metal of the organometallic compound and/or the organic salt is chosen from tin, lead, zinc, calcium, barium, and combinations thereof.

11. The composition of claim 10 wherein the organometallic compound and/or the salt is present in an amount of from about 0 to about 10 wt %, based on a total weight of the composition.

12. The composition of claim 1 further comprising an additive chosen from an acrylic homopolymer, an acrylic copolymer, a chlorinated polyethylene, a methyl methacrylate-butadiene-styrene copolymer, and combinations thereof.

13. The composition of claim 12 wherein the additive is present in an amount of from about 0 to about 10 wt %, based on a total weight of the composition.

14. The composition of claim 1 wherein the first lubricant exhibits a viscosity of from about 1 to about 50 cP, measured at about 120° C., according to ASTM D445.

15. A method of forming a composition, said method comprising the steps of:
providing polyvinyl chloride;
providing a first lubricant, wherein the first lubricant comprises a dimerization product of at least two linear alpha olefins that each comprises from about 20 to about 24 carbon atoms; and wherein the dimerization product comprises a first compound having from about 33 to about 44 carbon atoms and a second compound having from about 45 to about 60 carbon atoms; and
combining the polyvinyl chloride and the first lubricant to form the composition such that the polyvinyl chloride is present in an amount of from about 50 to about 95 wt %, and the first lubricant is present in an amount of from about 0.1 to about 3 wt %, each based on a total weight of the composition.

16. The method of claim 15 wherein the step of combining is further defined as blending the polyvinyl chloride and the first lubricant to form a mixture, and said method optionally comprises the step of heating the polyvinyl chloride and the first lubricant individually and/or in the mixture.

17. The method of claim 16 wherein the step of heating is performed and the step of heating has a fusion time delay, that is at least about 10% greater than the fusion time delay of a step of heating a comparative composition that is free of the first lubricant and comprises the polyvinyl chloride and a C30 linear alpha olefin or a paraffin wax, each is present in the same amount as the first lubricant.

18. The method of claim 15 wherein the composition exhibits a stability time, measured according to ASTM D2538-02, after the step of combining that is at least about 10% greater than a stability time of a comparative composition that is free of the first lubricant and comprises a C30 linear alpha olefin or a paraffin wax, each is present in the same amount as the first lubricant.

19. A method of forming an extruded product, said method comprising the steps of:
providing a composition comprising:
from about 50 to about 95 wt % of polyvinyl chloride, based on a total weight of the composition; and
from about 0.1 to about 3 wt % of a first lubricant, based on a total weight of the composition; wherein the first lubricant comprises a dimerization product of at least two linear alpha olefins that each comprises from about 20 to about 24 carbon atoms; and wherein the dimerization product comprises a first compound having from about 33 to about 44 carbon atoms and a second compound having from about 45 to about 60 carbon atoms.
extruding the composition through a die to form the extruded product.

20. The method of claim 19 wherein the step of extruding is performed with a force, measured according to ASTM D3835, that is at least about 10% less than a force to extrude a comparative composition that is free of the first lubricant.
